(19) United States
(12) Patent Application Publication
(10) Pub. No.: US 2024/0330366 A1
(43) Pub. Date: Oct. 3, 2024

(54) INFORMATION PROCESSING APPARATUS, INFORMATION PROCESSING SYSTEM, AND INFORMATION PROCESSING METHOD

(71) Applicant: Hitachi, Ltd., Tokyo (JP)

(72) Inventors: Sachiho ABE, Tokyo (JP); Kunihiko KIDO, Tokyo (JP)

(21) Appl. No.: 18/435,258

(22) Filed: Feb. 7, 2024

(30) Foreign Application Priority Data
Mar. 30, 2023 (JP) 2023-056453

(51) Int. Cl. G06F 16/901

(52) U.S. Cl. CPC G06F 16/9024

(57) ABSTRACT

A technique is provided for preventing an increase in calculation time in processing using a graph. An information processing method includes: calculating, by a processor, for a node of interest which is a node to be of interest in graph data, an index value relevant to a centrality of the node of interest; adding to the node of interest, by the processor, edges connected to a node group reached along one edge from the node of interest and storing an attribute of the node of interest as a node group in a memory when the index value of the centrality conforms to a condition; extracting, by the processor, a graph including the node of interest from a database related to a node interaction when the index value of the centrality does not conform to a condition; and integrating, by the processor, the extracted graph and the graph data.

### CROSS-REFERENCE TO RELATED APPLICATION

The present application claims priority from Japanese application JP2023-056453, filed on Mar. 30, 2023, the content of which is hereby incorporated by reference into this application.

### BACKGROUND OF THE INVENTION

### 1. Field of the Invention

The present invention relates to an information processing apparatus, an information processing system, and an information processing method.

### 2. Description of Related Art

There has been known a technique related to data processing using a graph. JP2020-181378A (PTL 1) discloses a technique capable of searching for relevance between elements that cannot be investigated using only a single database. That is, PTL 1 discloses “a relevance search method including combining a plurality of elements and a plurality of databases each including relevance information indicating direct relevance between two elements among the plurality of elements to create a combined database, and searching for relevance between two elements having no direct relevance using the combined database, in which a structure of the combined database is a graph structure in which the element is a node and the relevance information is an edge”. PTL 1 describes that “A structure of the combined database is a graph structure in which the element is a node and the relevance information is an edge.”.

### CITATION LIST

### Patent Literature

[PTL 1] JP2020-181378A

### SUMMARY OF THE INVENTION

In data processing using a graph, a calculation time may increase as the number of nodes to be calculated increases. Therefore, there is a problem in providing a technique to reduce the calculation time.

According to a first aspect of the invention, the following information processing apparatus is provided. The information processing apparatus includes a processor and a memory. The processor calculates, for a node of interest which is a node to be of interest in graph data, an index value relevant to a centrality of the node of interest. When the index value of the centrality conforms to a condition, the processor stores, in the memory, data of respective nodes reached along one edge from the node of interest and constitutes new graph data by connecting the node of interest and each node connected to the respective nodes. When the index value of the centrality does not conform to a condition, the processor detects an interaction between the node of interest and another node based on a graph including the node of interest extracted from a database related to a node interaction. Here, when the interaction is not detected, the processor stores, in the memory, data of respective nodes reached along one edge from the node of interest and constitutes new graph data by connecting the node of interest and each node connected to the respective nodes. On the other hand, when the interaction is detected, the processor stores, in the memory, data of respective nodes reached along one edge from the node of interest after integrating the interaction into the graph data and constitutes new graph data by connecting the node of interest and each node connected to the respective nodes in the graph data into which the interaction is integrated. A system that further includes a display device and is capable of displaying information is provided.

According to a second aspect of the invention, the following information processing apparatus is provided. The information processing apparatus includes a processor and a memory. The processor executes processing A and processing B in parallel for a first node and a second node which are nodes to be of interest in graph data. In the processing A, the processor calculates an index value relevant to a centrality of the first node. When the index value of the centrality conforms to a condition, the processor stores, in the memory, data of respective nodes reached along one edge from the first node. When the index value of the centrality does not conform to a condition, the processor detects an interaction between the first node and another node based on a graph including the first node extracted from a database related to a node interaction. When the interaction is not detected, the processor stores, in the memory, data of respective nodes reached along one edge from the first node. When the interaction is detected, the processor stores, in the memory, data of respective nodes reached along one edge from the node of interest after integrating the interaction into the graph data. In the processing B, the processor calculates an index value relevant to a centrality of the second node. When the index value of the centrality conforms to a condition, the processor stores, in the memory, data of respective nodes reached along one edge from the second node. When the index value of the centrality does not conform to a condition, the processor detects an interaction between the second node and another node based on a graph including the second node extracted from a database related to a node interaction. When the interaction is not detected, the processor stores, in the memory, data of respective nodes reached along one edge from the second node. When the interaction is detected, the processor stores, in the memory, data of respective nodes reached along one edge from the second node after integrating the interaction into the graph data. When the interaction is not detected in the processing A and the processing B, the processor constitutes new graph data by connecting the first node and each node connected to the respective nodes reached along one edge from the first node and connecting the second node and each node connected to the respective nodes reached along one edge from the second node. On the other hand, when the interaction is detected in the processing A and/or the processing B, the processor constitutes new graph data by connecting the first node and each node connected to the respective nodes reached along one edge from the first node and connecting the second node and each node connected to the respective nodes reached along one edge from the second node in the graph data into which the interaction is integrated.

According to a third aspect of the invention, the following information processing method is provided. The information processing method includes: calculating, by a processor, for a node of interest which is a node to be of interest in graph data, an index value relevant to a centrality of the node of interest; adding to the node of interest, by the processor, edges connected to a node group reached along one edge from the node of interest and storing an attribute of the node of interest as a node group in a memory when the index value of the centrality conforms to a condition; extracting, by the processor, a graph including the node of interest from a database related to a node interaction when the index value of the centrality does not conform to a condition; and integrating, by the processor, the extracted graph and the graph data.

According to the invention, a calculation time can be prevented from increasing as the number of nodes to be calculated increases. Problems, configurations, and effects other than those described above will become apparent in the following description of embodiments of the invention.

### BRIEF DESCRIPTION OF THE DRAWINGS

FIG. 1 is a diagram showing a configuration example of an information processing system;

FIG. 2 is a diagram showing an example of a data structure of graph data;

FIG. 3 is a diagram showing an example of a setting screen;

FIG. 4 is a flowchart showing an example of processing executed by an information processing apparatus in a first embodiment;

FIG. 5A is a diagram showing an example of a state of S401 shown in FIG. 4;

FIG. 5B is a diagram showing an example of a state of S406 shown in FIG. 4;

FIG. 5C is a diagram showing an example of a state of S407 shown in FIG. 4;

FIG. 6 is a diagram showing an example of an output screen;

FIG. 7 is a diagram showing an example of the output screen;

FIG. 8 is a flowchart showing an example of processing executed by the information processing apparatus in a second embodiment;

FIG. 9 is a diagram showing an example of a state in which no node is present between two nodes of interest in relation to processing of S803 in FIG. 8;

FIG. 10 is a diagram showing an example of the output screen; and

FIG. 11 is a diagram showing an example of a mathematical formula for obtaining a centrality score.

### DESCRIPTION OF EMBODIMENTS

Hereinafter, an embodiment according to the invention will be described with reference to the drawings. The embodiment is an example for describing the invention, and is omitted and simplified as appropriate for clarity of description. The invention can be implemented in various other aspects. Unless otherwise specified, each element may be single or plural.

In order to facilitate understanding of the invention, the position, size, shape, range, and the like of each element shown in the drawings may not represent the actual position, size, shape, range, and the like. Therefore, the invention is not necessarily limited to the position, size, shape, range, and the like disclosed in the drawings.

As examples of various types of information, expressions such as “table”, “list”, and “queue” may be used for description, but the various types of information may be expressed in a data structure other than these described. For example, various types of information such as “XX table”, “XX list”, and “XX queue” may be “XX information”. In description of identification information, when expressions such as “identification information”, “identifier”, “name”, “ID”, and “number” are used, the expressions can be replaced with one another.

When there are a plurality of elements having the same or similar functions, the same reference numerals may be assigned with different subscripts. When it is not necessary to distinguish the plurality of elements, the subscripts may be omitted from the description.

In the embodiment, processing performed by executing a program may be described. Here, a computer executes the program by a processor (for example, a CPU or a GPU) and performs processing defined by the program using a storage resource (for example, a memory), an interface device (for example, a communication port), or the like. Therefore, a subject of the processing performed by executing the program may be the processor. Similarly, the subject of the processing performed by executing the program may be a controller, an apparatus, a system, a computer, or a node including the processor. The subject of the processing performed by executing the program may be a calculation unit and may include a dedicated circuit that performs specific processing. Here, the dedicated circuit is, for example, a field programmable gate array (FPGA), an application specific integrated circuit (ASIC), or a complex programmable logic device (CPLD).

The program may be installed on the computer from a program source. The program source may be, for example, a program distribution server or a computer-readable storage medium. When the program source is the program distribution server, the program distribution server may include a processor and a storage resource for storing the program to be distributed, and a processor of the program distribution server may distribute the program to be distributed to another computer. In an embodiment, two or more programs may be implemented as one program, or one program may be implemented as two or more programs.

In the embodiment, a technique capable of reducing a calculation time in processing graph data including nodes and edges will be described.

### First Embodiment

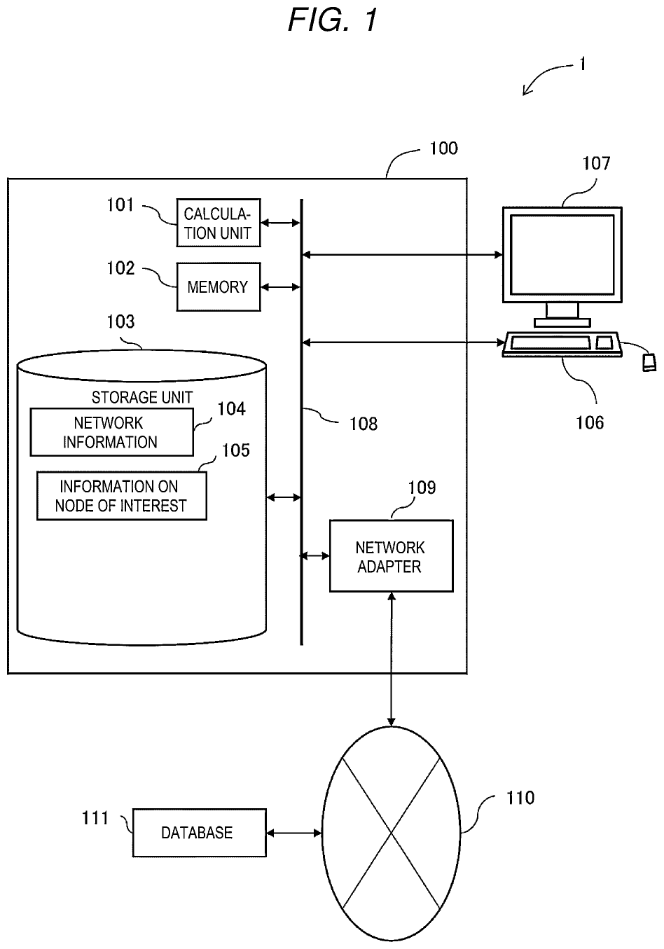

A first embodiment will be described with reference to FIGS. 1 to 7. First, a configuration example of a system will be described with reference to FIG. 1. As shown in FIG. 1, an information processing system 1 includes an information processing apparatus 100, an input unit 106, and an output unit 107.

The information processing apparatus 100 is implemented as an appropriate computer, and includes a calculation unit 101, a memory 102, a storage unit 103, and a network adapter 109. The information processing apparatus 100 includes an input and output interface (not shown) which is an interface used for inputting and outputting data. The components are connected via a bus 108.

The calculation unit 101 is a subject that executes calculation processing. The calculation unit 101 is implemented using a processor, and is implemented using a central processing unit (CPU) as an example. The calculation unit 101 may be a subject that executes predetermined calculation processing, and may be implemented using, for example, other semiconductor devices.

The memory 102 is a main storage device, and can be a random access memory (RAM) as an example. The calculation unit 101 temporarily stores necessary data in the memory 102 when executing predetermined processing.

The storage unit 103 is an auxiliary storage device, and can be a hard disk drive (HDD) as an example. The storage unit 103 may be implemented using other types of devices. The storage unit 103 stores appropriate data such as a program used for processing. In the present embodiment, the storage unit 103 stores information on graph data. That is, the storage unit 103 stores, for example, network information 104 and information 105 on a node of interest. The pieces of information (104, 105) will be described in detail later.

The network adapter 109 is used for communication with an external device. In the present embodiment, wireless communication with an external database 111 can be performed via the network adapter 109 and Internet 110.

The input unit 106 is used for data input by a user, and is implemented using an appropriate input device such as a keyboard or a mouse. The display unit 107 is used to present information to the user, and is appropriately implemented using a display (a display device). The input unit 106 and the display unit 107 may be integrated, and for example, the input unit 106 and the display unit 107 may be implemented by a touch panel. Data input and output to and from the information processing apparatus 100 is performed via the input and output interface.

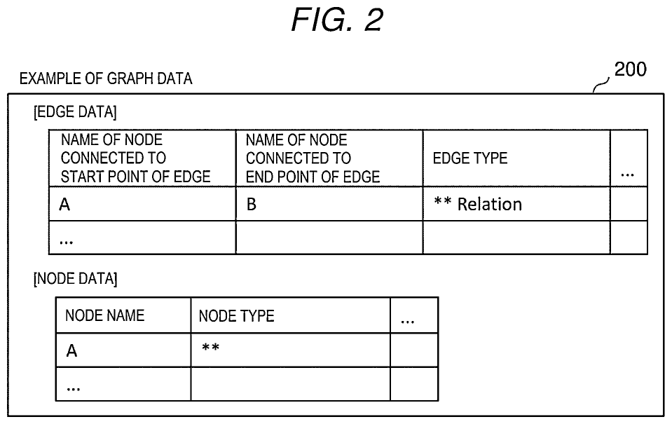

Next, the network information 104 and the information 105 on a node of interest will be described. The network information 104 is data that defines a network structure of graph data used for data processing. As shown in FIG. 2, as an example, the network information 104 includes edge data related to an edge and node data related to a node. As an example, the edge data includes names of nodes connected to a start point and an end point of an edge, and is data indicating each edge in graph data 200. As an example, the node data includes a name of each node in the graph data 200, and is a data indicating each node in the graph data 200.

Other pieces of data such as an edge type may be omitted in the edge data as long as the network structure of the graph data 200 can be appropriately expressed. Similarly, other pieces of data such as a node type may be omitted in the node data as long as the network structure of the graph data can be appropriately expressed. FIG. 2 is an example, and the data structure may be appropriately changed as long as the graph data 200 can be appropriately defined. For example, the graph data 200 is defined by edge data and node data in FIG. 2, and the graph data may be defined based on a single table.

The information 105 on a node of interest is data indicating an important node in the graph data 200. The information 105 on a node of interest may include, for example, data related to a node name. In the present embodiment, as will be described later, the information processing apparatus 100 can execute calculation related to the important node (also referred to as a node of interest).

A plurality of different pieces of graph data may be stored in the storage unit 103, and a database may be constructed by the plurality of pieces of graph data. That is, the network information 104 related to each piece of graph data and the information 105 on a node of interest may be stored in the storage unit 103.

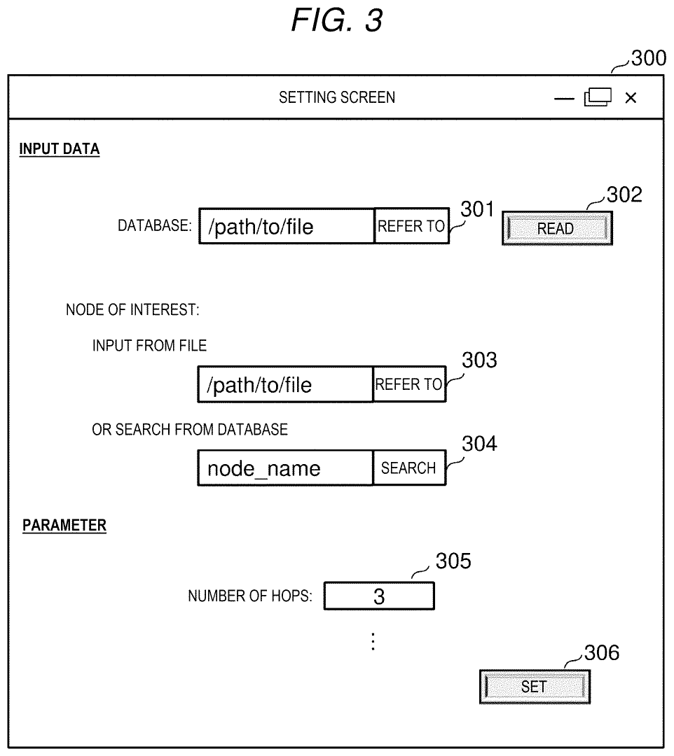

The information processing apparatus 100 can execute data processing of the graph data stored in the storage unit 103. In the present embodiment, an example of calculating a centrality score related to an important node selected by the user will be described. First, an initial setting will be described with reference to FIG. 3. FIG. 3 shows an example of a setting screen.

As shown in FIG. 3, the information processing apparatus 100 (specifically, the calculation unit 101) outputs a setting screen 300 to the display unit 107. The user of the information processing apparatus 100 can appropriately input data using the setting screen 300.

The setting screen 300 includes a field 301 and a read button 302. The field 301 is a field for inputting graph data to be processed, and the graph data to be processed is input by the user. When the user presses the read button 302, the graph data input in the field 301 is read from the storage unit 103. A list of the graph data stored in the storage unit 103 is output by pressing “refer to” in the field 301, and the user may input the graph data to be processed using the list.

The setting screen 300 includes a field 303. In the field 303, data in which a node of interest to be processed is described is input, and the node of interest is set. When the user presses “refer to”, a list of files in a local folder may be displayed and selected. When the graph data is input and the user presses “refer to”, a graph based on the graph data may be displayed. Then, the user can designate a node of interest on the displayed graph using, for example, a cursor. A graph may be displayed in which a node of interest and a node which is not a node of interest can be distinguished by highlighting based on an appropriate aspect such as color. When the cursor is placed on the node of interest, information indicating that the node is a node of interest may be displayed.

The setting screen 300 includes a field 304. In the field 304, a keyword for searching for a node of interest is input by the user. When the user presses “search”, a node of interest including the keyword (that is, a node of interest that hits the keyword) is extracted from the graph data to be processed, and a list of the extracted nodes of interest is displayed. The user can designate the node of interest by using the displayed list.

The user can designate the node of interest by using the field 303 or the field 304. In the field 305, the number of hops is input by the user. The number of hops indicates a range of nodes for which calculation is performed with the node of interest as a center. For example, when the number of hops is three, nodes reached along three edges from the node of interest are to be calculated. When the user presses a setting button 306, the designated node of interest and the number of hops are set.

The above setting screen 300 is an example, and a display mode of the setting screen 300 may be appropriately changed as long as the user can read the graph data to be processed, set the node of interest in the graph data, and set the number of hops. The setting screen 300 may display appropriate character information.

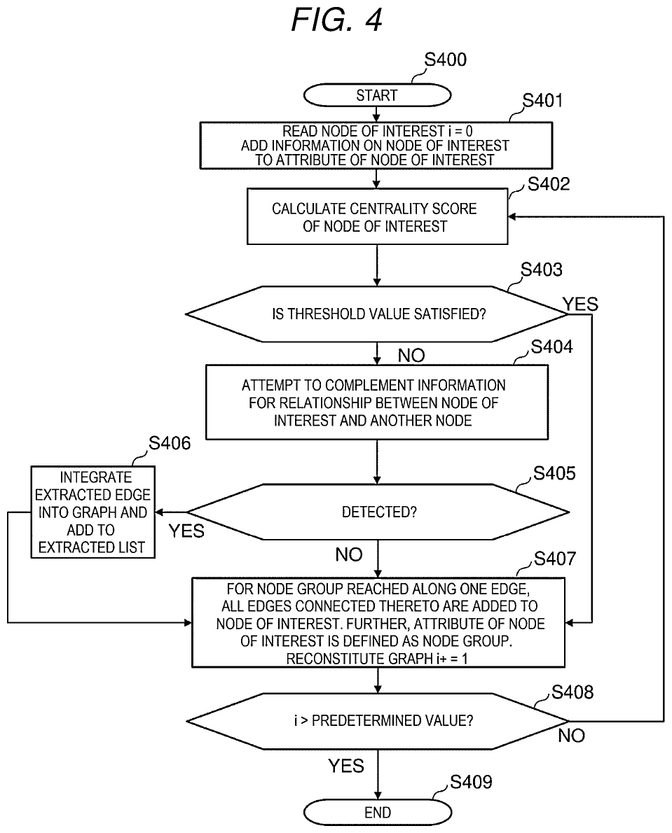

Next, an example of data processing will be described with reference to FIG. 4. In the data processing, graph data is expanded by repeating, for the set number of hops, an operation of calculating a centrality score of a node of interest and appropriately complementing the graph data according to a situation.

The data processing is started (S400), and the information processing apparatus 100 (more specifically, the calculation unit 101) reads the node of interest set by the user and adds information on the node of interest to an attribute of the node of interest (S401). An attribute of a node is data indicating a property and setting of the node, and the data is stored in the memory 102. The calculation unit 101 sets the number of times (the number of hops i) to repeat processing related to S402 to S408 to an initial value.

Next, the calculation unit 101 calculates a centrality score related to a node of interest (S402). Here, in calculation of the centrality score, all nodes of the graph may be used, or some nodes may be used.

Next, the calculation unit 101 determines whether the centrality score calculated in S402 conforms to a condition (S403). In the example, the calculation unit 101 determines whether the centrality score satisfies a predetermined threshold value. In S403, when the calculation unit 101 determines that the centrality score e calculated in S402 satisfies the predetermined threshold value, the processing proceeds to S407 to be described later (S403—YES). On the other hand, when the calculation unit 101 determines that the centrality score calculated in S402 does not satisfy the predetermined threshold value, the processing proceeds to S404 (S403—NO).

The calculation unit 101 performs information complement for a relationship between the node of interest and another node (that is, a node having no interaction with the node of interest in the current graph data or a node that is not included in the attribute node) (S404), and detects another node having an interaction with the node of interest (S405). When another node having an interaction with the node of interest is detected, the processing proceeds to S406 (S405—YES), and when another node having an interaction with the node of interest is not detected, the processing proceeds to S407 (S405—NO).

The calculation unit 101 complements an edge (that is, an edge connecting the detected node and the node of interest) and generates graph data into which the edge is integrated. The calculation unit 101 adds data of the edge to an extracted list to be described later (S406). In conjunction with this, the calculation unit 101 stores information on the edge in the network information 104, and the network information 104 is updated.

For each edge connecting the node group reached along one edge from the node of interest and a node that is neither the reached node nor the node of interest and that is further reached along an edge, the calculation unit 101 adds a side connected to the reached node to the node of interest and reconstitutes a graph. Further, the node group reached along one edge from the node of interest and edges connected to that nodes are deleted. The calculation unit 101 stores, in the memory 102, an attribute of the node reached along one edge from the node of interest, and sets the attribute of the node of interest as a node group. That is, the calculation unit 101 stores, in the memory 102, data of respective nodes reached along one edge from the node of interest and constitutes new graph data by connecting the node of interest and each node connected to the respective nodes. The calculation unit 101 increments a value set in S401 (S407).

The calculation unit 101 determines whether the value set in S401 is larger than a predetermined value (S408). The predetermined value is relevant to the number of hops set by the user, and is set such that the centrality score of the node of interest is calculated as many times as the set number of hops. When the centrality score of the node of interest is calculated up to the set number of hops (S408—YES), the processing ends (S409). When the centrality score of the node of interest is not calculated for the set number of hops (S408—NO), the processing returns to S402.

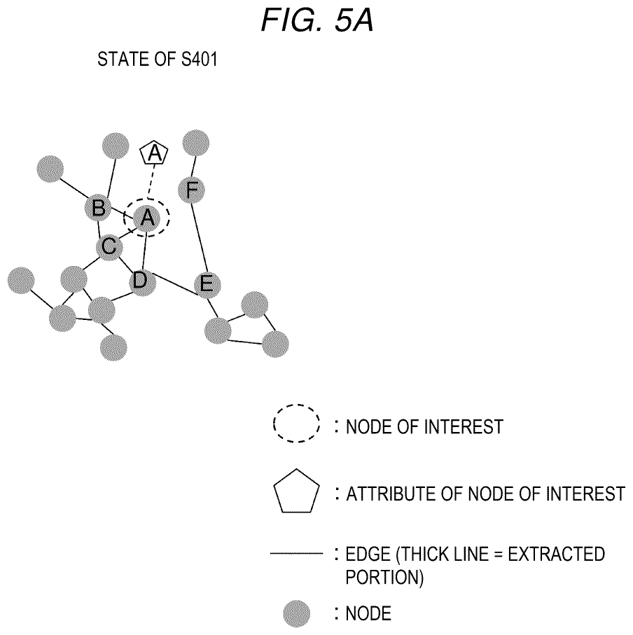

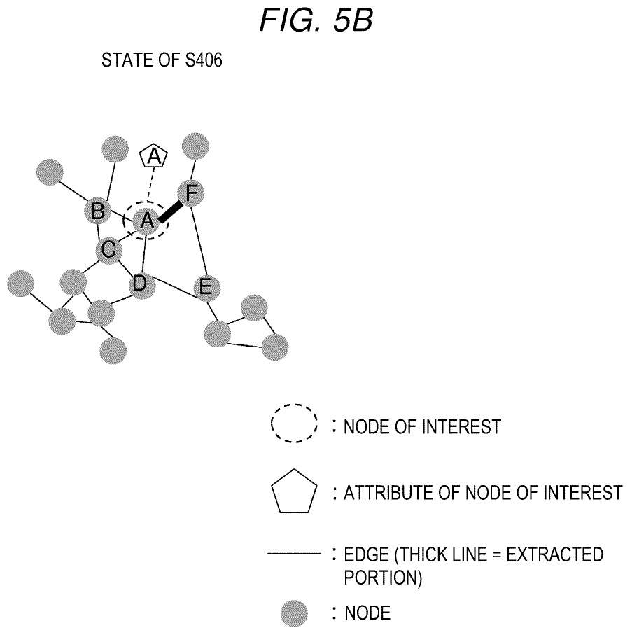

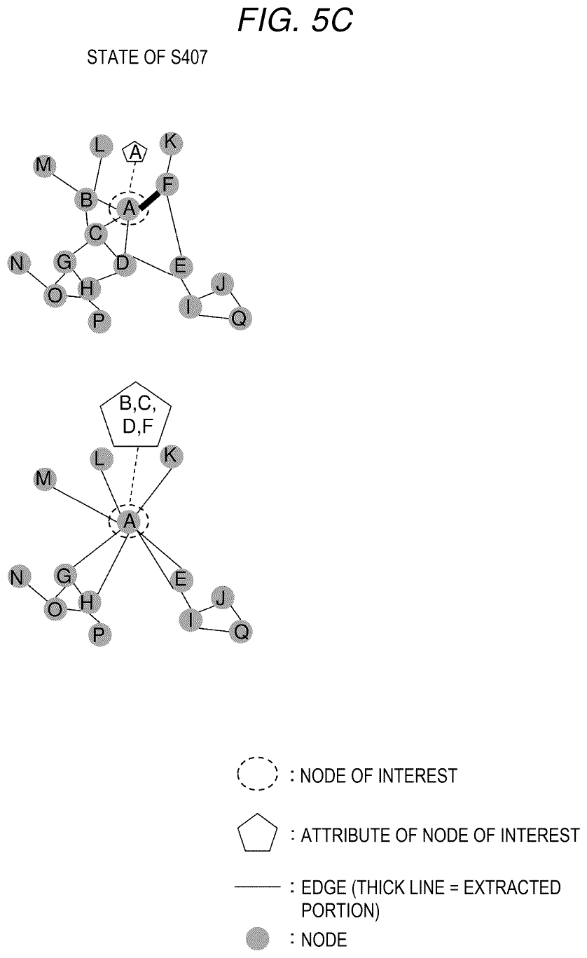

Next, examples of states of the graph data in S401, S406, and S407 will be described in detail with reference to FIGS. 5A to 5C. In FIGS. 5A to 5C, a node A may be set as the node of interest.

As shown in FIG. 5A, in S401, information on the node of interest A is added to an attribute of the node of interest A, and the attribute of the node of interest A is stored in the memory. When information is complemented in S404 and edges (A to F) indicating interactions are detected in S405, graph data into which the edges are integrated is generated in S406 as shown in FIG. 5B. A method for complementing the information in S404 may be, for example, a known method, and is not particularly limited as long as it is a method of appropriately evaluating a relationship with the node of interest.

For example, the calculation unit 101 may acquire graph data including the node of interest from the external database 111 related to the node, and may perform information complement using the acquired graph data. In this way, even when the graph data including the node of interest is frequently updated externally, a database based on the latest graph data can be easily constructed in the storage unit 103. Accordingly, the database can be enriched.

The information processing apparatus 100 may acquire graph data from the external database 111 using the network adapter 109 and perform processing of extracting interactions. A storage device (for example, a USB memory) in which a database is constructed may be connected to the information processing apparatus 100, and the information processing apparatus 100 may acquire graph data from the storage device and perform processing of extracting interactions.

As shown in FIG. 5C, in S407, new graph data is reconstituted by connecting the node of interest A to respective nodes (E, G, H, K, L, and M) connected to the node group (B, C, D, and F) reached from the node of interest A. Along with this, information on the nodes (B, C, D, and F), which are searched nodes, is stored in the memory 102 as the attribute of the node of interest.

When the processing is repeated based on the determination in S408, the calculation unit 101 calculates centrality scores of the nodes (E, G, H, K, L, and M) reached along one edge from the node of interest A based on the reconstituted graph. The calculation unit 101 stores, in the memory 102, information on the node group (E, G, H, K, L, and M) as the attribute of the node of interest, and reconstitutes graph data by connecting the respective nodes connected to the node group to the node of interest A. When a new interaction with the node of interest A is detected, information on the nodes related through the interaction is stored in the memory 102, and graph data into which the interaction is integrated is constituted. When a new interaction is detected, the network information 104 in the storage unit 103 is updated.

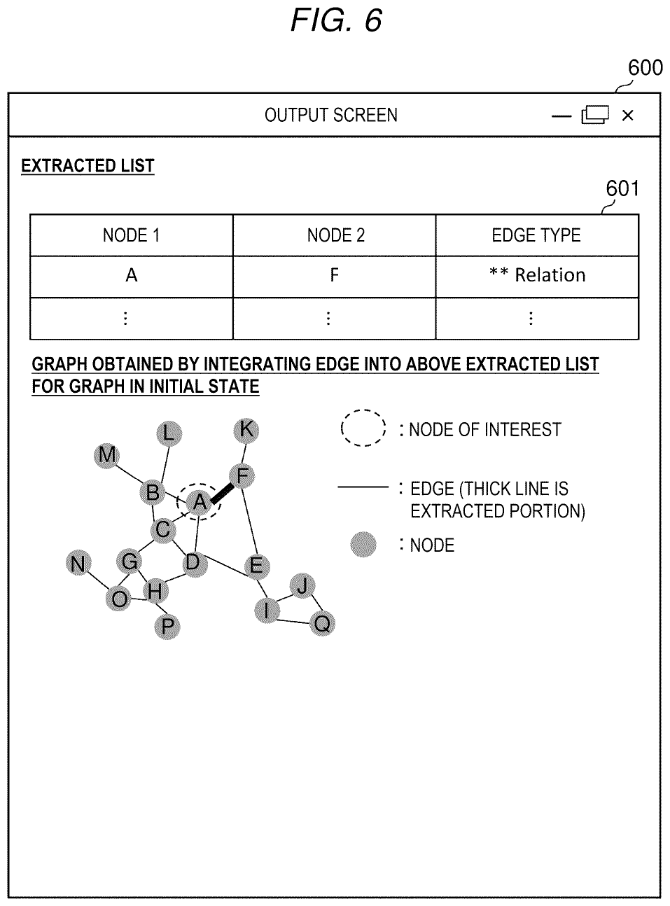

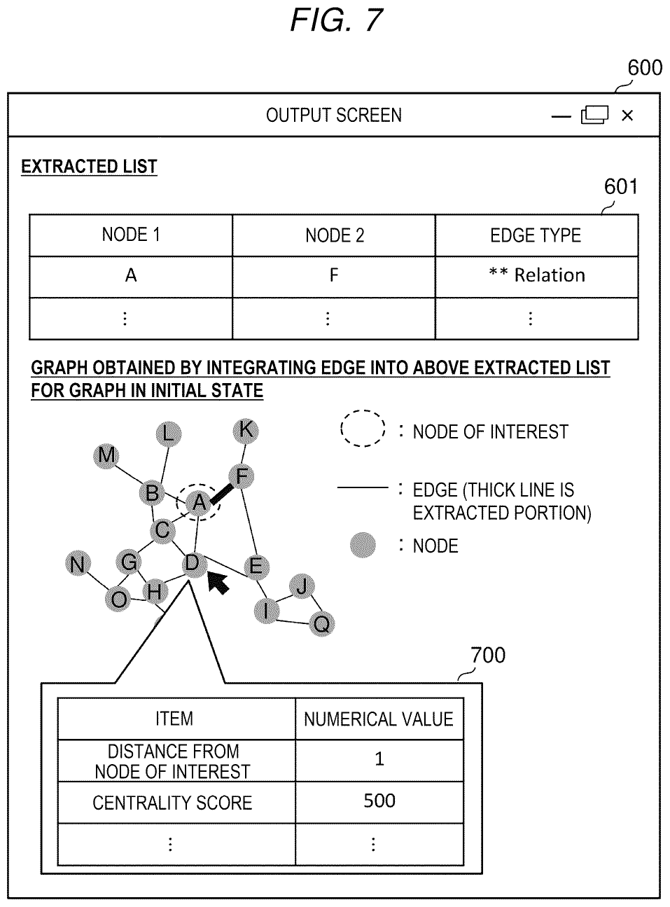

Next, an example of an output screen that can be displayed on the display unit 107 information processing apparatus 100 (specifically, the calculation unit 101) will be described with reference to FIGS. 6 and 7. As shown in FIG. 6, an output screen 600 includes information on an extracted list 601, which is a list of the edges extracted in S406. The user can recognize a new interaction integrated into the graph data by checking the extracted list 601.

The output screen 600 displays a graph based on graph data to be processed (that is, graph data at the start of processing). When there is an edge extracted in S406, a graph based on the graph data with the edge integrated is displayed. Here, the node of interest may be displayed in a more emphasized manner than other nodes. The extracted edge may be displayed in a more emphasized manner than other edges. A display mode of the graph shown in FIG. 6 is an example and can be appropriately changed. The output screen 600 may display appropriate character information.

As shown in FIG. 7, the node in the graph displayed on the output screen 600 can be selected by the cursor, and the user can select the node in the graph and refer to information on the selected node. Information 700 displayed when the user selects a node may include, for example, information on a distance from the node of interest and the centrality score of the node of interest. In the example in FIG. 7, the distance to the node of interest includes the number of hops from the node of interest and the centrality score of the node of interest up to the set number of hops. Information on the selected node (for example, a node name and node supplementary information) may be included.

In the graph processing, when the number of nodes to be calculated increases, a calculation time may increase. For example, it is considered that, when tracing one, two, . . . edges from a node to be of interest, the number of relevant nodes increases exponentially depending on the distance, and the calculation time related to the node to be of interest increases. To cope with such a problem that the calculation time increases, in the present embodiment, the calculation time can be reduced by combining already searched data to reconstitute a graph. Therefore, for example, even when the number of relevant nodes increases exponentially by tracing one, two, . . . edges from the node to be of interest, an increase in calculation time can be prevented. As a result of preventing an increase in calculation time, it is possible to contribute from an economical viewpoint.

When the centrality score does not satisfy the threshold value, construction of a database with a good centrality score for the node of interest can be facilitated by detecting a new interaction.

Further, by reconstituting the graph, whether to perform a search based on the centrality can be more efficiently determined (S403). For example, it is considered that, when estimating an insufficient interaction, it takes a fairly long time to evaluate the centrality of each node, but according to the present embodiment, an increase in time for estimating the insufficient interaction can be prevented.

### Second Embodiment

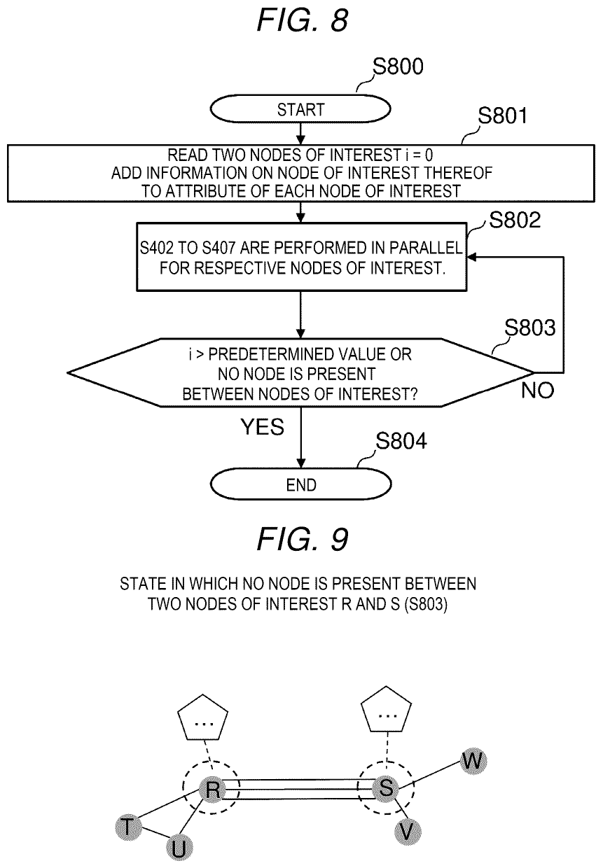

Next, a second embodiment will be described with reference to FIGS. 8 to 11. Contents different from those of the first embodiment will be described in detail, and descriptions of contents similar to those of the first embodiment may be omitted. In the drawings, the same reference numerals may be used for the same parts as those in the first embodiment. A hardware configuration of the second embodiment may be the same as the hardware configuration described in the first embodiment.

In the second embodiment, a plurality of nodes can be set as nodes of interest, and for example, a first node and a second node are set as the nodes of interest. A setting screen may be in any form as long as a node to be of interest and the number of hops can be set. The setting screen may be the same as that in the first embodiment, and for example, a plurality of nodes to be of interest may be set based on a format using a graph or a list. On the setting screen, the number of hops may be input for each node to be of interest.

An example of data processing in the second embodiment will be described with reference to FIG. 8. In the data processing, respective centrality scores of the first node and the second node are calculated.

The data processing is started (S800), and the information processing apparatus (specifically, the calculation unit 101) reads the first node and the second node set by the user, adds information on the first node to an attribute of the first node, and adds information on the second node to an attribute of the second node (S801). The attribute of each node is stored in a memory. The calculation unit 101 sets the number of times to repeat processing related to S802 to S803 to an initial value.

The calculation unit 101 performs processing the same as S402 to S407 for each of the first node and the second node in parallel for each of the nodes of interest. That is, the calculation unit 101 executes processing A related to the first node and processing B related to the second node in parallel. In the processing A, the calculation unit 101 calculates a centrality score of the first node, and stores, in the memory 102, attributes of respective nodes reached along one edge from the first node. Here, when a new interaction is detected in the processing A, an attribute of a node related to the interaction is stored in the memory 102. In the processing B, the calculation unit 101 calculates a centrality score of the second node, and stores, in the memory 102, attributes of respective nodes reached along one edge from the second node. Here, when a new interaction is detected in the processing B, an attribute of a node related to the interaction is stored in the memory 102.

The calculation unit 101 constitutes new graph data by connecting the first node and each node connected to the respective nodes reached along one edge from the first node and connecting the second node and each node connected to the respective nodes reached along one edge from the second node. Here, when a new interaction is detected, graph data into which the new interaction is integrated is constituted. The calculation unit 101 increments a value set in S801 (S802).

As in the first embodiment, the calculation unit 101 determines (1) whether the value set in S801 is larger than a predetermined value. The calculation unit 101 determines (2) whether a node is present between the nodes of interest (in the example, the first node and the second node) (S803). Here, when both (1) and (2) are not satisfied (that is, when the value set in S801 is equal to or less than the predetermined value and there is a node between the first node and the second node), the processing returns to S802 (S803—NO). On the other hand, when at least one of (1) and (2) is satisfied (that is, when the value set in S801 is larger than the predetermined value and/or there is no node between the first node and the second node), the processing proceeds to S804 (S803—YES). Then, the processing ends (S804).

Here, an example of a state in which there is no node between two nodes of interest, which is related to S803, will be described with reference to FIG. 9. By the calculation unit 101 reconstituting a graph, graph data may be constituted by connecting the first node R and the second node S, as shown in FIG. 9. When the graph data in this state (that is, a state in which no node exists between the first node R and the second node S) is constituted, the calculation unit 101 does not perform the processing again, and the processing ends.

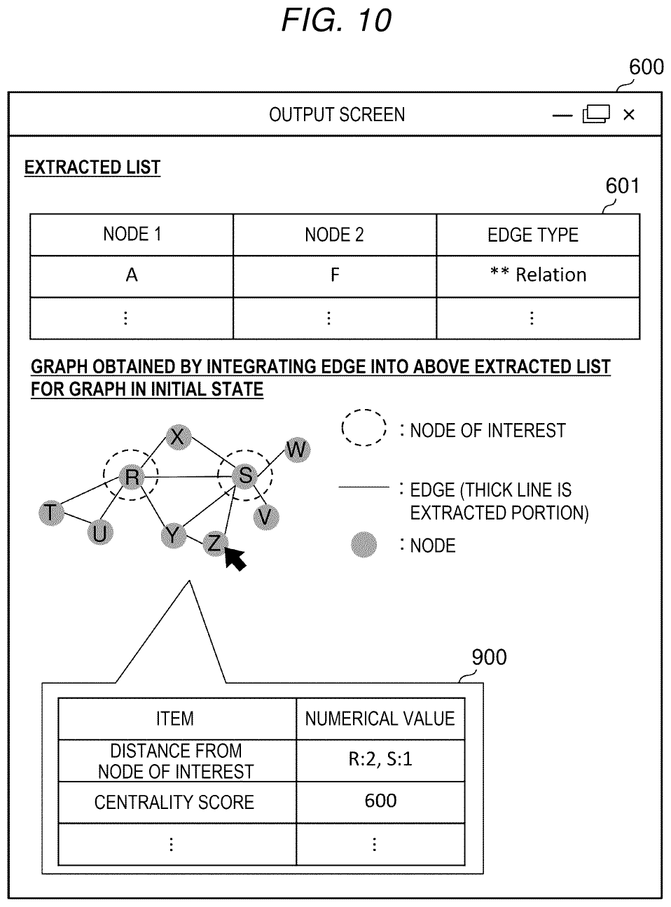

Next, an example of an output screen that can be displayed on the display unit 107 by the information processing apparatus (specifically, the calculation unit 101) will be described with reference to FIG. 10. Similar to the case of the first embodiment, the output screen 600 includes information on the extracted list 601 which is a list of extracted edges (new interactions detected in the processing A and the processing B).

The output screen 600 displays a graph based on graph data to be processed (that is, graph data at the start of processing). When there is an edge, a graph based on the graph data with the edge integrated is displayed. As in the first embodiment, the node of interest may be displayed in an emphasized manner, or the extracted edge may be displayed in an emphasized manner. As in the first embodiment, information on the selected node can be displayed, and in the present embodiment, for example, information 900 on distances from the first node and the second node and a centrality score is displayed on the output screen 600. In the example, the centrality score of one of the first node and the second node is displayed, or the centrality scores of the first node and the second node may also be displayed. A display mode of the graph shown in FIG. 10 is an example and can be appropriately changed.

Although the embodiments have been described above, the invention is not limited to the above-described embodiments, and includes various modifications and equivalent configurations within the scope of the claims.

For example, the above-described embodiments have been described in detail to facilitate understanding of the invention, and the invention is not limited to those including all the above-described configurations. Another configuration may be added to a part of the configuration of the embodiments, and a part of the configuration of each embodiment may be deleted or replaced with another configuration.

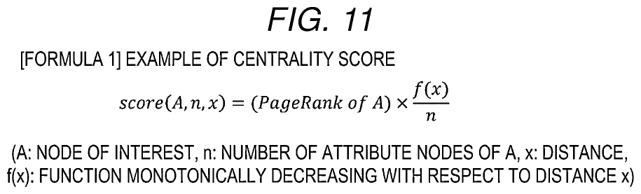

The calculation unit 101 can calculate the index value relevant to the centrality (the centrality score) based on, for example, one or a plurality among degree, eigenvector, closeness, betweenness, and pagerank. In the embodiments described above, as shown in formula 1 in FIG. 11, the calculation unit 101 calculates the centrality score based on the pagerank.

The graph data processed by the information processing apparatus may be a directed graph or an undirected graph. Although an example has been described in which the information processing apparatus uses the network adapter 109 to perform wireless communication, the information processing apparatus may also use the network adapter 109 to perform wired communication.

When the node in the graph data indicates a named entity, the information processing apparatus evaluates the relationship between the node of interest and another node based on known natural language processing in the information complement in S404.

The threshold value used in the determination in S403 can be appropriately set by the user. For example, the user may set a centrality threshold value such that the vicinity of the node of interest becomes dense, for the purpose of constructing a database that stores data with a good centrality score for the node of interest.

What is claimed is:

1. An information processing apparatus comprising:
a processor; and
a memory, wherein
the processor calculates, for a node of interest which is a node to be of interest in graph data, an index value relevant to a centrality of the node of interest,
when the index value of the centrality conforms to a condition, the processor stores, in the memory, data of respective nodes reached along one edge from the node of interest and constitutes new graph data by connecting the node of interest and each node connected to the respective nodes,
when the index value of the centrality does not conform to a condition, the processor detects an interaction between the node of interest and another node based on a graph including the node of interest extracted from a database related to a node interaction,
when the interaction is not detected, the processor stores, in the memory, data of respective nodes reached along one edge from the node of interest and constitutes new graph data by connecting the node of interest and each node connected to the respective nodes, and
when the interaction is detected, the processor stores, in the memory, data of respective nodes reached along one edge from the node of interest after integrating the interaction into the graph data and constitutes new graph data by connecting the node of interest and each node connected to the respective nodes in the graph data into which the interaction is integrated.

2. The information processing apparatus according to claim 1, wherein
the processor generates a list including information on the detected interaction.

3. The information processing apparatus according to claim 1, wherein
the processor repeats, for a predetermined number of times, processing of calculating an index value relevant to a centrality of a node of interest in graph data, storing, in the memory, data of respective nodes reached along one edge from the node of interest, and constituting new graph data.

4. An information processing system comprising:
the information processing apparatus according to claim 2; and
a display device, wherein
the processor outputs, to the display device, the information on the detected interaction included in the list.

5. An information processing system comprising:
the information processing apparatus according to claim 1; and
a display device, wherein
when the interaction is not detected, the processor outputs, to the display device, a graph which is based on the graph data, and
when the interaction is detected, the processor outputs, to the display device, a graph which is based on the graph data into which the interaction is integrated.

6. The information processing system according to claim 5, wherein
the processor outputs, to the display device, the graph in which the detected interaction is emphasized more than other interactions.

7. The information processing apparatus according to claim 1, wherein
the processor calculates the index value relevant to the centrality based on one or a plurality among degree, eigenvector, closeness, betweenness, and pagerank.

8. An information processing apparatus comprising:
a processor; and
a memory, wherein
the processor executes processing A and processing B in parallel for a first node and a second node which are nodes to be of interest in graph data,
in the processing A,
the processor calculates an index value relevant to a centrality of the first node,
when the index value of the centrality conforms to a condition, the processor stores, in the memory, data of respective nodes reached along one edge from the first node,
when the index value of the centrality does not conform to a condition, the processor detects an interaction between the first node and another node based on a graph including the first node extracted from a database related to a node interaction,
when the interaction is not detected, the processor stores, in the memory, data of respective nodes reached along one edge from the first node, and
when the interaction is detected, the processor stores, in the memory, data of respective nodes reached along one edge from the first node after integrating the interaction into the graph data,
in the processing B,
the processor calculates an index value relevant to a centrality of the second node,
when the index value of the centrality conforms to a condition, the processor stores, in the memory, data of respective nodes reached along one edge from the second node,
when the index value of the centrality does not conform to a condition, the processor detects an interaction between the second node and another node based on a graph including the second node extracted from a database related to a node interaction,
when the interaction is not detected, the processor stores, in the memory, data of respective nodes reached along one edge from the second node, and
when the interaction is detected, the processor stores, in the memory, data of respective nodes reached along one edge from the second node after integrating the interaction into the graph data,
when the interaction is not detected in the processing A and the processing B, the processor constitutes new graph data by connecting the first node and each node connected to the respective nodes reached along one edge from the first node and connecting the second node and each node connected to the respective nodes reached along one edge from the second node, and
when the interaction is detected in the processing A and/or the processing B, the processor constitutes new graph data by connecting the first node and each node connected to the respective nodes reached along one edge from the first node and connecting the second node and each node connected to the respective nodes reached along one edge from the second node in the graph data into which the interaction is integrated.

9. The information processing apparatus according to claim 8, wherein
the processor generates a list including information on the detected interaction.

10. The information processing apparatus according to claim 8, wherein
the processor repeats the processing A and the processing B and the processing of constituting the new graph data for a predetermined number of times and/or until no node is present between the first node and the second node in the new graph data.

11. An information processing system comprising:
the information processing apparatus according to claim 9; and
a display device, wherein
the processor outputs, to the display device, the information on the detected interaction included in the list.

12. An information processing system comprising:
the information processing apparatus according to claim 8; and
a display device, wherein
when the interaction is not detected in the processing A and the processing B, the processor outputs, to the display device, a graph which is based on the graph data, and
when the interaction is detected in the processing A and/or the processing B, the processor outputs, to the display device, a graph which is based on the graph data into which the interaction is integrated.

13. The information processing system according to claim 12, wherein
the processor outputs, to the display device, the graph in which the detected interaction is emphasized more than other interactions.

14. The information processing apparatus according to claim 8, wherein
the processor calculates the index value relevant to the centrality based on one or a plurality among degree, eigenvector, closeness, betweenness, and pagerank.

15. An information processing method comprising:
calculating, by a processor, for a node of interest which is a node to be of interest in graph data, an index value relevant to a centrality of the node of interest;
adding to the node of interest, by the processor, edges connected to a node group reached along one edge from the node of interest and storing an attribute of the node of interest as a node group in a memory when the index value of the centrality conforms to a condition;
extracting, by the processor, a graph including the node of interest from a database related to a node interaction when the index value of the centrality does not conform to a condition; and
integrating, by the processor, the extracted graph and the graph data.
